(19) United States
(12) Patent Application Publication
(10) Pub. No.: US 2008/0103973 A1
(43) Pub. Date: May 1, 2008

(54) ELECTRONIC SURVEILLANCE METHOD AND SYSTEM

(75) Inventors: Man-Ho PARK, Daejeon-city (KR); Byung-Sik YOON, Daejeon-city (KR); Song-In CHOI, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 11/759,894

(22) Filed: Jun. 7, 2007

(30) Foreign Application Priority Data
Oct. 30, 2006 (KR) 10-2006-0105583

(51) Int. Cl. H04L 9/00

(52) U.S. Cl. 705/51

(57) ABSTRACT

The present invention relates to an electronic surveillance method and system in a wideband wireless access system. If a law enforcement agency system requests electronic surveillance relative to a specified object, an electronic surveillance system first performs an authentication process using a codebook to authorize the electronic surveillance request. As the result of the authentication process, if it is judged that the electronic surveillance request of the law enforcement agency system is legal, the electronic surveillance system issues an encryption key required for encrypting communication contents with a law enforcement agency and electronic surveillance information. Thereafter, communication and message transmission/reception between the electronic surveillance system and the law enforcement agency system are encrypted and decoded using the encryption key. Accordingly, an illegal electronic surveillance request by an unauthorized user can be blocked, and an encryption key is issued to only an authorized user, such that the authorized user is authorized to access electronic surveillance information. With the authentication process and the encryption, the electronic surveillance information is protected doubly. Therefore, illegal access by an unauthorized user can be prevented.

### CROSS-REFERENCE TO RELATED APPLICATION

This application claims priority to and the benefit of Korean Patent Application No. 10-2006-0105583 filed in the Korean Intellectual Property Office on Oct. 30, 2006, the entire contents of which are incorporated herein by reference.

### BACKGROUND OF THE INVENTION

(a) Field of the Invention

The present invention relates to an electronic surveillance method and system in a wideband wireless access system. In particular, the invention relates to a method and system that perform an authentication process for verifying an electronic surveillance request and, when it is judged that the electronic surveillance request is legal, performs electronic surveillance.

(b) Description of the Related Art

A wideband wireless access system refers to a next generation communication system that supports mobility in addition to a local area data communication system using a fixed access point, such as a known wireless local area network (WLAN). In respect to the wideband wireless access system, various standards have been proposed, and IEEE 802.16e is in the International standardization stage for the wideband wireless access system.

In recent years, cases where high-tech communication technology, such as a wideband wireless access system, have been misused for crimes and terrorism have been on the increase. In order to effectively cope with the crimes and terrorism, more efforts have focused on the further development and efficient use of an electronic surveillance function. However, the development of new communication systems and the development of existing communication systems make it difficult to perform electronic surveillance. Accordingly, a method that puts a communication service provider under an obligation to provide a legal electronic surveillance function has been discussed over the entire world.

The term “electronic surveillance” means that a law enforcement agency having legal rights collects communication information of communication subscribers. Also, it is used meaning of lawful interception (hereinafter, referred to as “LI”). In order for the service provider to carry out the electronic surveillance function, he/she needs to separate electronic surveillance information from an illegal third person through an appropriate method, such as encryption or the like, so as to prevent an infringement on human rights due to misuse of the electronic surveillance information by the illegal third person.

In a circuit network as known PSTN (public switched telephone network) or the like, the electronic surveillance is generally made through direction connection to a specified line. In this case, the third person may not acquire the interception contents. Meanwhile, in the packet communication network, such as the wideband wireless access system, the communication contents are not transmitted through a specified line, but are transmitted through several general-use paths in packets. Accordingly, while the service provider collects the electronic surveillance information of the communication subscribers and transmits the information to the law enforcement agency, the contents may be copied at many steps. This may cause degradation of security of the electronic surveillance.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an electronic surveillance method and system, having advantages of increasing reliability and security of electronic surveillance by performing a reliable authentication process on an electronic surveillance request from a law enforcement agency system to perform authorization when the electronic surveillance is performed in a wideband wireless access system, and encrypting communication contents and electronic surveillance contents between the wideband wireless access system and the law enforcement agency system.

An exemplary embodiment of the present invention provides an electronic surveillance method of an electronic surveillance system, which provides electronic surveillance information of a specified subscriber terminal to a law enforcement agency system connected to the electronic surveillance system through a network.

The electronic surveillance includes causing the electronic surveillance system to receive a electronic surveillance request message including an index of an encryption key and an encrypted authentication value from the law enforcement agency system, reading out a first encryption key and a first authentication key corresponding to the index from a codebook stored in a database and decoding the authentication value with the first encryption key, when the decoding result of the authentication value with the first encryption key is consistent with the first authentication key, generating a second encryption key and transmitting the generated second encryption key to the law enforcement agency system so as to authorize electronic surveillance, causing the electronic surveillance system to receive the details of the electronic surveillance from the authorized law enforcement agency system and to collect the electronic surveillance information of the specified subscriber terminal according to the details of the electronic surveillance, and causing the electronic surveillance system to encrypt the collected electronic surveillance information with the second encryption key and to transmit the encrypted information to the law enforcement agency system.

Another embodiment of the present invention provides an electronic surveillance system that provides electronic surveillance information of a specified subscriber terminal to a law enforcement agency system connected thereto through a network.

The electronic surveillance system includes an electronic surveillance administration system that performs an authentication process according to an electronic surveillance request message received from the law enforcement agency system, generates an encryption key according to the authentication result, and provides the generated encryption key to the law enforcement agency system; a collection system that collects electronic surveillance information of the subscriber terminal including electronic surveillance related information and electronic surveillance content information and outputs the collected information; and an information delivery system that encrypts the collected and output electronic surveillance information on the basis of the encryption key and transmits the encrypted information to the law enforcement agency system.

### BRIEF DESCRIPTION OF THE DRAWINGS

FIG. 1 is a network architecture of a law enforcement agency system and a wideband wireless access system connected to each other through an IP network according to an exemplary embodiment of the present invention.

FIG. 2 is a detailed block diagram of an electronic surveillance system according to an exemplary embodiment of the present invention.

FIG. 3 is a detailed network architecture showing a case in which a law enforcement agency system and an electronic surveillance system according to an exemplary embodiment of the present invention are connected to each other through an IP network to perform electronic surveillance of a subscriber terminal.

FIG. 4 is a detailed block diagram of a law enforcement agency system according to an exemplary embodiment of the present invention.

FIG. 5 is a flowchart showing a method of performing electronic surveillance according to an exemplary embodiment of the present invention.

FIG. 6 is a flowchart showing an electronic surveillance authentication method according to an exemplary embodiment of the present invention.

### DETAILED DESCRIPTION OF THE EMBODIMENTS

In the following detailed description, only certain exemplary embodiments of the present invention have been shown and described, simply by way of illustration. However, the present invention can be implemented in various ways, but it is not limited to the exemplary embodiment disclosed herein. Accordingly, the drawings and description are to be regarded as illustrative in nature and not restrictive. Like reference numerals designate like elements throughout the specification.

It will be understood that the terms “comprises”, “comprising”, “includes”, and “including”, when used herein, specify the presence of constituent elements, but do not preclude the presence or addition of other constituent elements.

Hereinafter, an electronic surveillance system according to an exemplary embodiment of the present invention will be described in detail with reference to the drawings.

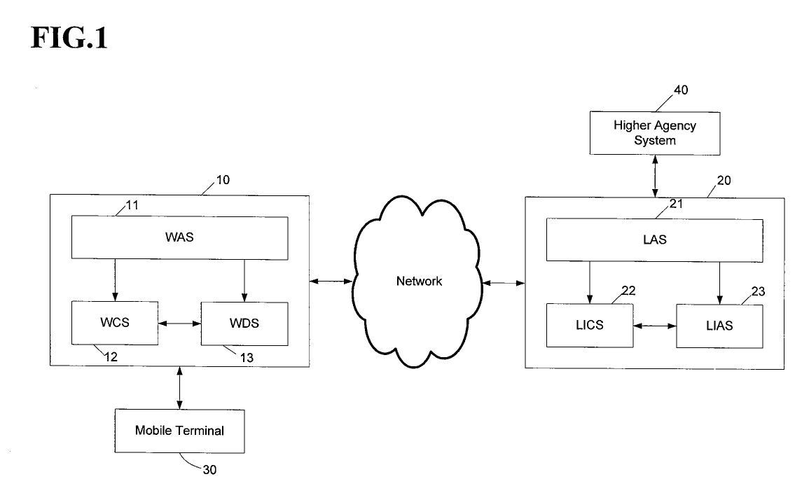

FIG. 1 is a network architecture of a law enforcement agency (hereinafter referred to as “LEA”) system 20 and an electronic surveillance system 10 in a wideband wireless access system according to an exemplary embodiment of the present invention. The electronic surveillance system 10 performs electronic surveillance of a specified subscriber terminal through communication with the law enforcement agency system 20.

Referring to FIG. 1, the electronic surveillance system 10 includes an electronic surveillance administration system (WiBro administration system; hereinafter referred to as “WAS”) 11, a collection system (WiBro collection system; hereinafter referred to as “WCS”) 12, and an information delivery system (WiBro delivery system; hereinafter referred to as “WDS”) 13. The systems are connected to each other through a network. Further, a subscriber terminal (portable subscriber terminal; hereinafter referred to as “PSS”) 30 that is subject to the electronic surveillance is connected to the electronic surveillance system 10. One electronic surveillance system 10 can cover a plurality of subscriber terminals 30.

The subscriber terminals 30 are all wireless devices according to the wideband wireless access system physical standard and the MAC (media access control) standard enacted by the wideband wireless access system project group (PG302) within the Telecommunication Technology Association (hereinafter referred to as “TTA”). Such terminals include laptops, PDAs, and smart phones, and each terminal is mounted with an Internet browser for accessing the wideband wireless access system to use wireless Internet services.

The law enforcement agency system 20 is connected to the electronic surveillance system 10 through the network. The law enforcement agency system 20 includes an administration system (LEA administration system; hereinafter referred to as “LAS”) 21 and an information collection system (LI collection system; hereinafter referred to as “LICS”) 22. In addition, the law enforcement agency system 20 further includes an information analysis system (LI analysis system; hereinafter referred to as “LIAS”) 23 that is connected to the LICS 22. A higher agency system 40 may also be connected to the law enforcement agency system 20.

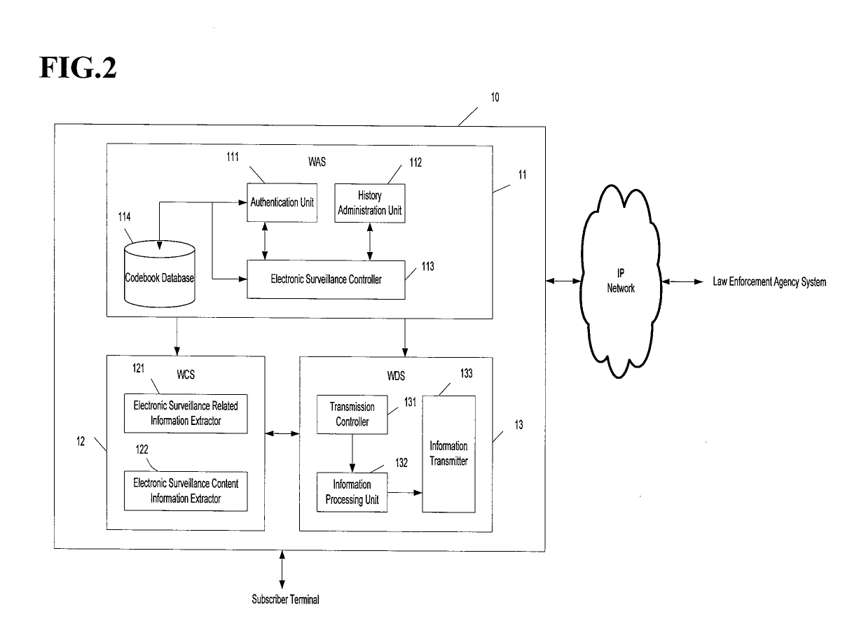

FIG. 2 is a detailed view of an electronic surveillance system, which performs electronic surveillance in a wideband wireless access system, according to the exemplary embodiment of the present invention.

As shown in FIG. 2, the electronic surveillance system 10 receives and processes an electronic surveillance request from the law enforcement agency system 20, performs substantial electronic surveillance of the subscriber terminal 30, and collects electronic surveillance information. Further, the electronic surveillance system 10 encrypts the collected electronic surveillance information and transmits the encrypted electronic surveillance information to the law enforcement agency system 20.

To this end, as shown in FIG. 2, the electronic surveillance system 10 in the wideband wireless access system according to the exemplary embodiment of the present invention includes the WAS 11, the WCS 12, and the WDS 13.

Among the functions of the electronic surveillance system 10, the WAS 11 performs a function of receiving and processing the electronic surveillance request from the law enforcement agency system 20, and a function of controlling the WCS 12 and the WDS 13 to deliver the electronic surveillance contents to the law enforcement agency system 20. Further, the WAS 11 performs an authentication process relative to the electronic surveillance request and manages electronic surveillance histories.

When the electronic surveillance request of the law enforcement agency system 20 is legal, the WCS 12 receives a control message from the WAS 11, and accesses electronic surveillance related information (intercept related information; hereinafter also referred to as “IRI”) of a specified object and electronic surveillance content information (content of communication; hereinafter also referred to as “CC”) as communication content information of an object that is subject to electronic surveillance corresponding to the control message. Further, the WCS 12 transmits the electronic surveillance related information (IRI) and electronic surveillance content information (CC) collected through the access to the WDS 13. The WDS 13 transmits the information to the law enforcement agency system 20. At this time, the electronic surveillance related information (IRI) includes identification information required for the electronic surveillance of the subscriber terminal, such as hardware information relative to traffic processing of the subscriber terminal, tunneling information of a packet call of the subscriber terminal, and information about whether the subscriber terminal is in use.

Among the functions of the electronic surveillance system 10, the WDS 13 performs a function of an electronic surveillance information delivery module in the wideband wireless access system. That is, the WDS 13 receives response data of an electronic surveillance request, electronic surveillance related information (IRI), and electronic surveillance content information (CC) from the WCS 12 according to the request of the WAS 11 and transmits them to the law enforcement agency system 20.

Meanwhile, the WAS 11 includes an authentication unit 111, a history administration unit 112, an electronic surveillance controller 113, and a codebook database (hereinafter referred to as “codebook DB”) 114. The authentication unit 111 receives an electronic surveillance request message including an encryption key index and an authentication value from the law enforcement agency system 20, and reads a first encryption key and a second authentication key required for authentication from the codebook DB 114, thereby performing the authentication process. The history administration unit 112 receives, from the law enforcement agency system 20, details on electronic surveillance including a law enforcement agency that carries out the electronic surveillance, an object that is subject to the electronic surveillance, an electronic surveillance range, and an electronic surveillance duration, and administrates an electronic surveillance history relative to the specified object. The electronic surveillance controller 113 transmits a second encryption key, which is used for encrypting and decoding the electronic surveillance information to be transmitted and received according to the result of the authentication process by the authentication unit 111, to the law enforcement agency system 20 and the WDS 13. At this time, when the second encryption key is transmitted to the law enforcement agency system 20, the second encryption key is encrypted with the first encryption key, such that the second encryption key can be prevented from being exposed to an illegal third person.

Meanwhile, the code book DB 114 stores a codebook that is created and distributed by the higher agency system 40, which authenticates the electronic surveillance request of the law enforcement agency system 20, such that the electronic surveillance system 10 performs the authentication process relative to the electronic surveillance request of the law enforcement agency system 20. In the codebook DB 114, the encryption key and the authentication key are classified according to the index of the encryption key. The codebook DB 114 is used when the authentication unit 111 performs the authentication process relative to the electronic surveillance request.

That is, the law enforcement agency system 20 requests the higher agency system 40 for legal permission relative to the electronic surveillance. If the electronic surveillance is legally permitted, the encryption key, the authentication key, and the index corresponding to the encryption key as authentication parameters required for authentication are issued from the codebook. The law enforcement agency system 20 generates the authentication value on the basis of the issued authentication parameters, and transmits the electronic surveillance request message including the encryption key index and the authentication value to the electronic surveillance system 10. Then, the electronic surveillance system 10 performs the authentication process relative to the electronic surveillance request of the law enforcement agency system 20 on the basis of the first encryption key and the first authentication key read from the codebook DB 114 according to the received encryption key index and the authentication value in the electronic surveillance request message.

The WCS 12 includes an electronic surveillance related information extractor 121 and an electronic surveillance content information extractor 122. The electronic surveillance related information extractor 121 accesses the electronic surveillance related information (IRI) of the subscriber terminal, and delivers the extracted electronic surveillance related information (IRI) to the WDS 13. The electronic surveillance content information extractor 122 accesses the electronic surveillance content information (CC) of the subscriber terminal, and delivers the extracted electronic surveillance content information (CC) to the WDS 13.

The WDS 13 includes a transmission controller 131, an information processing unit 132, and an information transmitter 133. The transmission controller 131 receives the control message including the second encryption key from the WAS 11, delivers the second encryption key to the information processing unit 132, and controls the information processing unit 132 according to the control message, thereby administrating the transmission/reception of the electronic surveillance information (IRI, CC). The information processing unit 132 receives the electronic surveillance information (IRI, CC) from the WCS 12, encrypts the received electronic surveillance information (IRI, CC) with the second encryption key received from the WAS 11, and outputs the encrypted electronic surveillance information. The information transmitter 133 receives the encrypted electronic surveillance information (IRI, CC) from the information processing unit 132, and transmits the received electronic surveillance information (IRI, CC) to the law enforcement agency system 20. The WDS 13 performs the electronic surveillance under the control of the WAS 11, encrypts the electronic surveillance content information (CC) and the electronic surveillance related information (IRI) with the second encryption key received from the WAS 11, and delivers the encrypted electronic surveillance content information (CC) and electronic surveillance related information (IRI) to the law enforcement agency system 20.

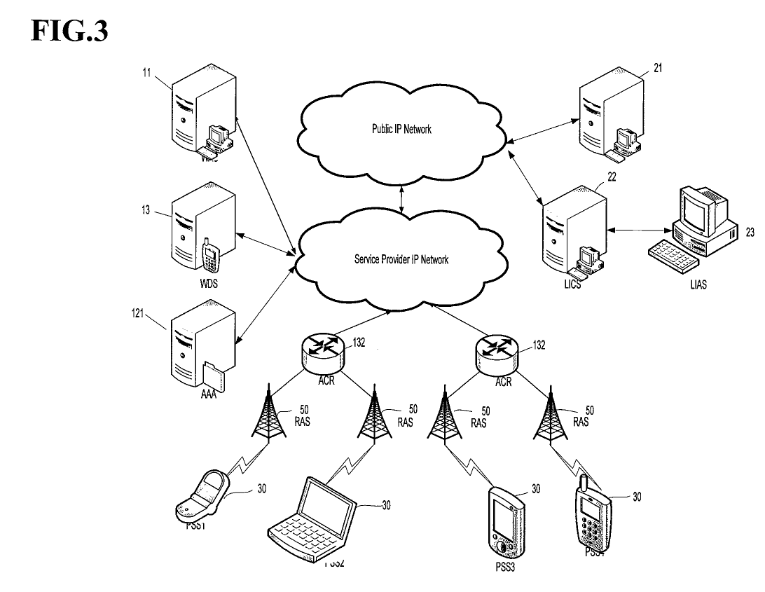

FIG. 3 shows an example where the electronic surveillance system 10 and the law enforcement agency system 20 according to the exemplary embodiment of the present invention are connected to each other through an IP network, and the electronic surveillance relative to the subscriber terminals 30 is performed.

Referring to FIG. 3, an authentication, authorization, and accounting (hereinafter referred to as “AAA”) unit functions as the electronic surveillance related information extractor 121 of the WCS 12. Further, a base station controller (access control router; hereinafter referred to as “ACR”) functions as the electronic surveillance content information extractor 122. Accordingly, the AAA unit is represented by reference numeral “121”, and the ACR is represented by reference numeral “122”.

When the electronic surveillance request from the law enforcement agency system 20 is legal, the AAA unit 121 accesses the electronic surveillance related information (IRI) and delivers the electronic surveillance related information (IRI) to the WDS 13. At this time, the electronic surveillance related information (IRI) includes identification information required for the electronic surveillance relative to the subscriber terminal, such as hardware information relative to traffic processing of the subscriber terminal, tunneling information of a packet call of the subscriber terminal, and information about whether the subscriber terminal is in use.

When the electronic surveillance request of the law enforcement agency system 20 is legal, the ACR 122 accesses the electronic surveillance content information (CC) of the object that is subject to electronic surveillance, extracts the electronic surveillance content information (CC) as the communication content information, and transmits the extracted electronic surveillance content information (CC) to the WDS 13.

In addition, the AAA unit 121 functions as a server that authenticates the subscriber terminal 30 and charges a fee in a service network. The ACR 122 functions as a base station controller in the wideband wireless access system. The ACR 122 covers a plurality of RASs 50. Accordingly, the ACR 122 also functions as a packet access router that connects the RASs 50 or the RASs 50 and the IP network. The RAS 50 functions as a base station in the wideband wireless access system and transmits packet data received from the ACR 122 to the PSS 30 in a wireless manner. The RAS 50 functions as network equipment that performs wireless resource administration and mobility (hand-off) support functions, that is, a bridge that connects a wireless network and a cable network. One RAS 50 covers a plurality of PSSs 30.

In FIG. 3, the electronic surveillance related information extractor of the WCS 12 is implemented by the AAA unit 121, and the electronic surveillance content information extractor is implemented by the ACR 122. However, the present invention is not limited thereto. For example, according to the kind of subscriber terminal that is subject to electronic surveillance and the position of the electronic surveillance system in the wideband wireless access system, the electronic surveillance related information extractor and the electronic surveillance content information extractor can be implemented in various ways.

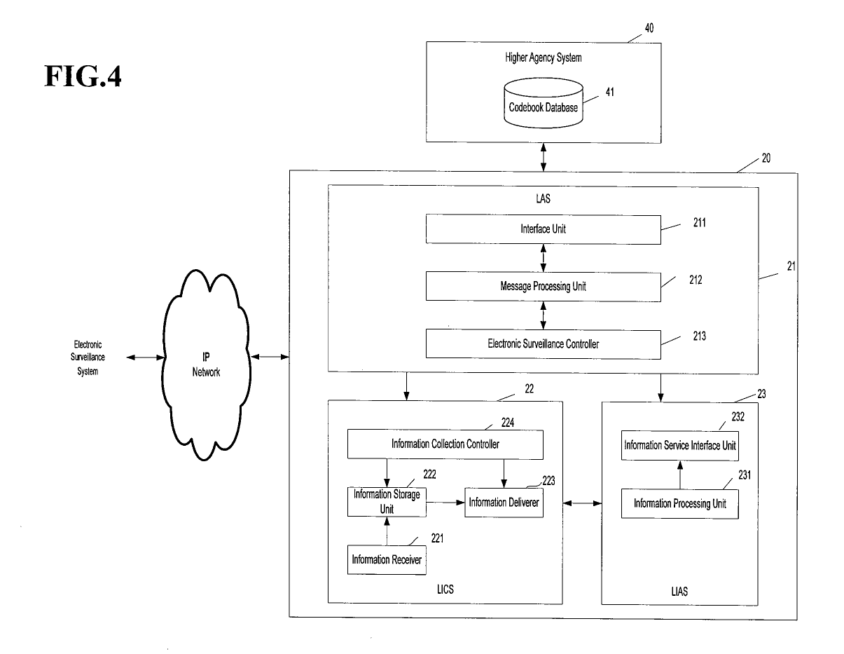

Hereinafter, the law enforcement agency system 20 according to the exemplary embodiment of the present invention will be described in detail with reference to FIG. 4.

FIG. 4 is a detailed view of the law enforcement agency system 20 according to the exemplary embodiment of the present invention.

The law enforcement agency system 20 informs the electronic surveillance system 10 in the wideband wireless access system of the electronic surveillance request. Then, if the electronic surveillance system 10 transmits the encrypted electronic surveillance information, the law enforcement agency system 20 receives and administrates the electronic surveillance information. Then, if an administrator of the law enforcement agency requests the stored electronic surveillance information, the law enforcement agency system 20 decodes the electronic surveillance information and provides the decoded electronic surveillance information to the administrator.

To this end, as shown in FIG. 4, the law enforcement agency system 20 according to the exemplary embodiment of the present invention includes the LAS 21, the LICS 22, and the LIAS 23.

The LAS 21 requests the electronic surveillance system 10 for legal electronic surveillance relative to the specified object, delivers electronic surveillance related control information, and controls the LICS 22. Further, the LAS 21 performs an electronic surveillance authentication process according to the exemplary embodiment of the present invention.

The LICS 22 collects the electronic surveillance information from the WDS 13 of the electronic surveillance system 10 under the control of the LAS 21, and administrates the collected electronic surveillance information in a database. Meanwhile, one LICS 22 covers a plurality of WDSs 13.

If the administrator of the law enforcement agency requests electronic surveillance data, the LIAS 23 receives the electronic surveillance information from the LICS 22, analyzes the received electronic surveillance information, and outputs the analyzed electronic surveillance information.

The LAS 21 includes an interface unit 211, a message processing unit 212, and an electronic surveillance controller 213. The interface unit 211 performs message transmission and reception with the electronic surveillance system 10. The message processing unit 212 receives and decodes the encrypted second encryption key from the electronic surveillance system 10, encrypts the details of the electronic surveillance with the second encryption key, and outputs the encrypted details of the electronic surveillance. If the administrator of the law enforcement agency requests the electronic surveillance, the electronic surveillance controller 213 delivers the electronic surveillance request and the details of the electronic surveillance to the electronic surveillance system 10, receives the second encryption key from the electronic surveillance system 10, and delivers the received second encryption key to the LICS 22. The electronic surveillance controller 213 controls the LICS 22 to control the reception time of the electronic surveillance information. Further, the electronic surveillance controller 213 receives the authentication parameters from the higher agency system 40 and generates the authentication value, which is to be transmitted to the electronic surveillance system 10, using the received authentication parameters.

Particularly, the authentication parameters that are used in the electronic surveillance controller 213 include the encryption key index, the encryption key, and the authentication key. The authentication parameters are issued by the higher agency system 40, which authenticates the electronic surveillance, using the codebook. The codebook used at that time is included in the higher agency system 40. The higher agency system 40 stores the codebook, which has the same contents as the codebook stored in the electronic surveillance system 10 for the authentication process of the electronic surveillance, in a codebook DB 41, issues the authentication parameters from the codebook DB 41 when the law enforcement agency system 20 requests the electronic surveillance, and delivers the issued authentication parameters to the law enforcement agency system 20.

The LICS 22 includes an information receiver 221, an information storage unit 222, an information deliverer 223, and an information collection controller 224. The information receiver 221 receives the encrypted electronic surveillance information from the electronic surveillance system 10. The information storage unit 222 receives the encrypted electronic surveillance information from the information receiver 221 and the second encryption key from the LAS 21, and stores and administrates the encrypted electronic surveillance information and the second encryption key. The information deliverer 223 transmits the encrypted electronic surveillance information and the second encryption key to the LIAS 23. The information collection controller 224 receives the control message including the second encryption key from the LAS 21, and determines a collection time of the electronic surveillance information from the electronic surveillance system 10. Then, when the LIAS 23 requests to deliver the electronic surveillance information, the information collection controller 224 controls the electronic surveillance information to be delivered. Meanwhile, the encrypted electronic surveillance information received by the LICS 22 is encrypted with the second encryption key received from the LAS 21.

The LIAS 23 includes an information processing unit 231 and an information service interface unit 232. The information processing unit 231 receives the encrypted electronic surveillance information and the second encryption key from the LICS 22, and decodes the electronic surveillance information with the second encryption key. If the administrator of the law enforcement agency requests the information service, the information service interface unit 232 transmits an information delivery request to the LICS 22 and delivers the electronic surveillance information decoded by the information processing unit 231 to the administrator. At this time, the information service interface unit 232 delivers the electronic surveillance information in forms to be recognized by the administrator of the law enforcement agency. The forms include text, sound, or motion picture to be recognized by the administrator.

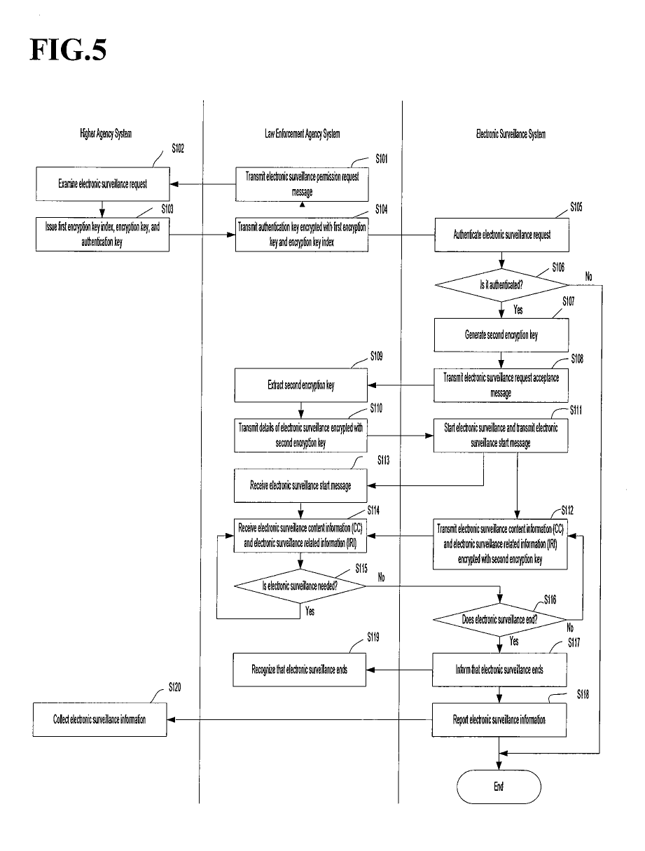

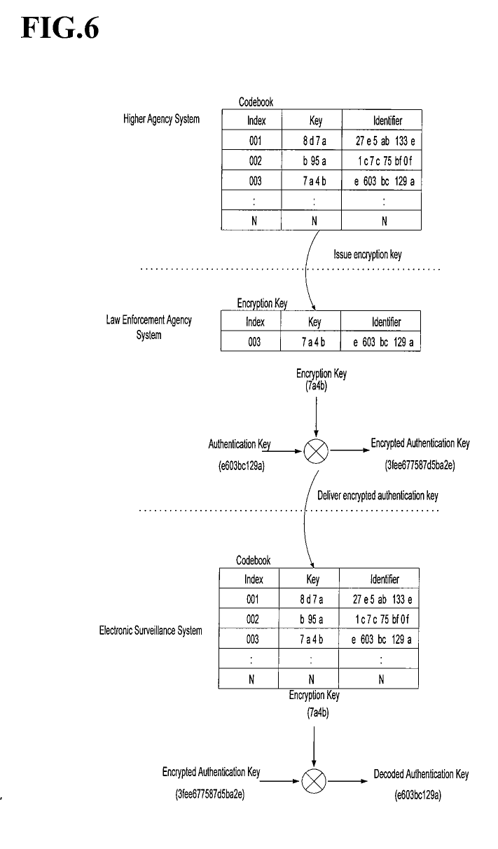

Hereinafter, an electronic surveillance method according to an exemplary embodiment of the present invention that is performed by the electronic surveillance system 10 in the wideband wireless access system will be described in detail with reference to FIGS. 5 and 6, by way of the structures of the electronic surveillance system 10 and law enforcement agency system 20.

FIG. 5 is a flowchart showing a process of electronic surveillance that is performed by the electronic surveillance system 10 according to an exemplary embodiment of the present invention.

As shown in FIG. 5, if the electronic surveillance relative to the specified object is required, the law enforcement agency system 20 transmits an electronic surveillance authentication request message including information, such as a reason for electronic surveillance, information about the object that is subject to electronic surveillance, and the electronic surveillance range and duration, to the higher agency system 40, which is connected to the law enforcement agency system 20 through the network, and requests to perform the electronic surveillance (Step S101). The higher agency system 40 receives the electronic surveillance permission request message from the law enforcement agency system 20 and permits the electronic surveillance when it is determined that the electronic surveillance is needed (Step S102). Meanwhile, in the exemplary embodiment of the present invention, the process in which the law enforcement agency system 20 requests the higher agency system 40 for the electronic surveillance and the electronic surveillance is permitted has been described by way of the transmission/reception of the message and information through the network. However, the present invention is not necessarily limited thereto. For example, the law enforcement agency system 20 may request the higher agency system 40 for the electronic surveillance offline, receive information according to the request, and store and administrate the received information in its own system.

Further, the higher agency system 40 provides the index of the encryption key, the encryption key corresponding to the index, and the authentication key to the law enforcement agency system 20, such that the contents of the electronic surveillance permitted to the law enforcement agency system 20 can be authenticated from the electronic surveillance system 10 in the wideband wireless access system (Step S103).

At this time, the higher agency system 40 prescribes the encryption key and the authentication key, creates the codebook, distributes the codebook to the electronic surveillance system 10, and stores a codebook having the same contents as the codebook in the codebook DB 41, such that the electronic surveillance system 10 can perform the authentication process to authorize the electronic surveillance request. Then, if the electronic surveillance permission request message is received from the law enforcement agency system 20, the higher agency system 40 issues the index of the encryption key, the encryption key, and the authentication key on the basis of the codebook. The electronic surveillance system 10 stores the codebook issued by the higher agency system 40 in the codebook DB 114 of the WAS 11 and performs the authentication process relative to the electronic surveillance using the codebook.

If the higher agency system 40 permits the electronic surveillance relative to the specified object, the LAS 21 in the law enforcement agency system 20 generates the authentication value, which is obtained by encrypting the authentication key with the encryption key, using the index of the encryption key, the encryption key, and the authentication key delivered from the higher agency system 40 in respect to the permission of the electronic surveillance. The authentication value encrypted with the encryption key in such a manner is included in the electronic surveillance request message, together with the index of the encryption key, and is then transmitted to the electronic surveillance system 10 (Step S104).

The WAS 11 that receives the electronic surveillance request message from the law enforcement agency system 20 performs the authentication process relative to the request (Step S105).

First, the WAS 11 extracts the encryption key index and the authentication value from the electronic surveillance request message that is received from the law enforcement agency system 20. Next, the first encryption key and the first authentication key corresponding to the extracted encryption key index are read out from the codebook stored in the codebook DB 114. At this time, as described above, the codebook includes the encryption key and the authentication key that are prescribed by the higher agency system 40 and the electronic surveillance system 10.

The encryption key read from the codebook DB 114 is used to decode the authentication value extracted from the electronic surveillance request message. The WAS 11 generates the authentication key by decoding the authentication value and compares the generated authentication key with the first authentication key read from the codebook. Here, if both are the same, it is judged that the electronic surveillance request is legal (Step S106).

If it is judged that the electronic surveillance request is legal (Step S106), the WAS 11 generates the second encryption key (Step S107). The second encryption key generated at this time is used to encrypt data corresponding to a message to be subsequently generated through a predetermined procedure, and electronic surveillance related information (IRI) and electronic surveillance content information (CC) due to the electronic surveillance for the law enforcement agency system 20.

Meanwhile, the WAS 11 that generates the second encryption key transmits an electronic surveillance request acceptance message including the second encryption key to the law enforcement agency system 20, and informs that the requested electronic surveillance is accepted (Step S108). At this time, the WAS 11 encrypts the electronic surveillance request acceptance message with the first encryption key corresponding to the encryption key index received from the law enforcement agency system and transmits the encrypted electronic surveillance request acceptance message. This is to prevent an unauthorized third person from acquiring the second encryption key and to prevent information leakage upon transmission/reception of the electronic surveillance information.

The LAS 21 in the law enforcement agency system 20 receives the encrypted electronic surveillance request acceptance message, decodes the received electronic surveillance request acceptance message, and extracts the second encryption key (Step S109). Then, if it is recognized that the electronic surveillance request is permitted, the details of the electronic surveillance including the object that is subject to electronic surveillance, the electronic surveillance range, and the electronic surveillance duration are transmitted to the electronic surveillance system (Step S110). At this time, the message to be transmitted is encrypted with the second encryption key. All the subsequent communication contents between the law enforcement agency system 20 and the electronic surveillance system 10 are encrypted with the second encryption key to be then protected.

The WAS 11 that receives the details of the electronic surveillance from the law enforcement agency system 20 controls the WCS 12 of the electronic surveillance system 10 to start the electronic surveillance relative to the specified object, and informs the law enforcement agency system 20 that the electronic surveillance starts (Step S111).

Accordingly, the WCS 12 performs the electronic surveillance relative to the specified object subject to electronic surveillance according to the details of the electronic surveillance and delivers the electronic surveillance content information (CC) and the electronic surveillance related information (IRI) to the WDS 13. Then, the WDS 13 encrypts data corresponding to the electronic surveillance content information (CC) and the electronic surveillance related information (IRI) with the second encryption key and transmits the encrypted electronic surveillance content information (CC) and electronic surveillance related information (IRI) to the LICS 22 in the law enforcement agency system 20 (Step S112). At this time, in the WCS 12, a method of performing the electronic surveillance relative to the specified object and acquiring the electronic surveillance content information (CC) and the electronic surveillance related information (IRI) can be implemented by a person of ordinary skill in the art, and thus the description thereof will be omitted.

The LAS 21 in the law enforcement agency system 20 receives the electronic surveillance start message (Step S113) and recognizes that the electronic surveillance starts. Thereafter, the LAS 21 receives data about the electronic surveillance content information (CC) and the electronic surveillance related information (IRI) supplied from the electronic surveillance system 10 (Step S114) and performs the electronic surveillance.

If the law enforcement agency system 20 judges that the electronic surveillance may end (Step S115) and requests the electronic surveillance system 10 to end the electronic surveillance or if the electronic surveillance duration is expired, the electronic surveillance system 10 ends the electronic surveillance (Step S116). Further, the electronic surveillance system 10 informs the law enforcement agency system 20 that the electronic surveillance ends (Step S117), and reports the information related to the electronic surveillance (the law enforcement agency, the object that is subject to electronic surveillance, the electronic surveillance range, and the electronic surveillance duration) to the higher agency system according to the prescribed procedure (S118).

Accordingly, the law enforcement agency system 20 recognizes that the electronic surveillance ends (Step S119), and the information related to the electronic surveillance is reported to the higher agency system 40 (Step S120). Then, the electronic surveillance ends.

Hereinafter, a method of using a codebook to prevent illegal leakage of the authentication and electronic surveillance contents relative to the electronic surveillance request of the law enforcement agency system 20 according to the exemplary embodiment of the present invention will be described with reference to FIG. 6.

FIG. 6 is a flowchart showing a codebook, which is used to secure the electronic surveillance authentication and communication contents between the law enforcement agency system 20 and the electronic surveillance system 10, and a method of applying the codebook.

As shown in FIG. 6, when the law enforcement agency system 20 requests the higher agency system 40 for the electronic surveillance relative to the specified object and the higher agency system 40 permits the electronic surveillance, the index of the encryption key and the encryption key for the encryption of the authentication key and the authentication key for the authentication are issued from the codebook stored in the codebook DB 41 according to the prescribed procedure. For example, if the higher agency system 40 issues the encryption key and the authentication key corresponding to the index number 3 of the codebook, the encryption key index number 3 corresponding to the encryption key, the encryption key (7a4b), and the authentication key (e603bc129a) are delivered to the law enforcement agency system 20.

Thereafter, the LAS 21 in the law enforcement agency system encrypts the authentication key (e603bc129a) with the delivered encryption key (7a4b) to generate the authentication value (3fee677587d5ba2e), and delivers the electronic surveillance request message including the encryption key index (3) and the authentication value (3fee677587d5ba2e) to the electronic surveillance system 10.

The WAS 11 of the electronic surveillance system 10 that receives the electronic surveillance request from the law enforcement agency system 20 extracts the encryption key index (3) and the authentication value (3fee677587d5ba2e) from the request message. Further, the WAS 11 reads the first encryption key (7a4b) and the first authentication key (e603bc129a) corresponding to the extracted encryption key index (3) from the codebook stored in the codebook DB 114, decodes the authentication value (3fee677587d5ba2e) with the first encryption key (7a4b) read from the codebook, and compares the authentication key (e603bc129a) decoded from the authentication value and the first authentication key (e603bc129a) read from the codebook. That is, the WAS 11 confirms whether the authentication key decoded from the authentication value and the first authentication key read from the codebook stored in the electronic surveillance system 10 according to the encryption key index, to thereby confirm whether the electronic surveillance request of the law enforcement agency system 20 is lawfully performed.

If it is confirmed that the electronic surveillance request is legal, the WAS 11 generates the second encryption key to be used to encrypt the electronic surveillance related information and the electronic surveillance content information when the electronic surveillance is performed. In order to secure the second encryption key upon transmission, in the same manner that the law enforcement agency system 20 encodes the authentication key, the second encryption key (7a4b) is encoded. Then, the encoded second encryption key (7a4b) is included in a message informing that the electronic surveillance request is accepted, and is then transmitted to the law enforcement agency system 20. Subsequently, all the control messages and the electronic surveillance content and related information between the electronic surveillance system 10 and the law enforcement agency system 20 are encrypted with the second encryption key to be then transmitted.

As such, the electronic surveillance method performs the authentication process on the electronic surveillance request using the prescribed encryption key, encrypts the electronic surveillance content and related information by the electronic surveillance, and delivers the encrypted electronic surveillance content and related information. According to the electronic surveillance method, the electronic surveillance contents to be transmitted can be prevented from leaking to an unauthorized third person. Therefore, an infringement of the human rights of the object that is subject to electronic surveillance can be prevented, and the electronic surveillance contents can be prevented from being misused.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment of the present invention, the authentication process is performed on the electronic surveillance request using the codebook, and thus only the authorized user is allowed to request the electronic surveillance. Further, the encryption key that is used to encrypt the electronic surveillance information is encrypted and transmitted using the codebook, and then the electronic surveillance contents are encrypted with the encryption key. Accordingly, the electronic surveillance information can be encrypted and protected doubly, and reliability and security relative to the electronic surveillance can be increased. Therefore, the electronic surveillance contents can be prevented from leaking to an unauthorized third person and being misused.

What is claimed is:

1. An electronic surveillance method of an electronic surveillance system, which provides electronic surveillance information of a specified subscriber terminal to a law enforcement agency system connected to the electronic surveillance system through a network, the electronic surveillance method comprising:
causing the electronic surveillance system to receive an electronic surveillance request message including an index of an encryption key and an encrypted authentication value from the law enforcement agency system;
reading a first encryption key and a first authentication key corresponding to the index from a codebook stored in a database, and decoding the authentication value with the first encryption key;
when the decoding result of the authentication value with the first encryption key is consistent with the first authentication key, generating a second encryption key and transmitting the generated second encryption key to the law enforcement agency system so as to authorize electronic surveillance request of the law enforcement agency system;
causing the electronic surveillance system to receive the details of the electronic surveillance from the authorized law enforcement agency system, and to collect the electronic surveillance information relative to the specified subscriber terminal according to the details of the electronic surveillance; and
causing the electronic surveillance system to encrypt the collected electronic surveillance information with the second encryption key and to transmit the encrypted electronic surveillance information to the law enforcement agency system.

2. The electronic surveillance method of claim 1, further comprising causing the law enforcement agency system to decode the electronic surveillance information received from the electronic surveillance system with the second encryption key.

3. The electronic surveillance method of claim 1, wherein, in the generating and transmitting of the second encryption key, the second encryption key is encrypted with the first encryption key and then transmitted to the law enforcement agency system.

4. The electronic surveillance method of claim 1, wherein the codebook is delivered from a higher agency system, which authorizes the electronic surveillance request of the law enforcement agency system, and includes an encryption key and an authentication key classified according to the encryption key index.

5. The electronic surveillance method of claim 1, wherein the authentication value is encrypted by the law enforcement agency system using the encryption key and the authentication key delivered from the higher agency system, and the encryption key and the authentication key are delivered from a codebook having the same contents as the codebook.

6. The electronic surveillance method of claim 1, wherein the details of the electronic surveillance include information about the law enforcement agency that performs the electronic surveillance, an object that is subject to electronic surveillance, an electronic surveillance range, and an electronic surveillance duration.

7. The electronic surveillance method of claim 1, wherein the electronic surveillance information includes electronic surveillance related information and electronic surveillance content information, the electronic surveillance related information includes hardware information relative to traffic processing of the subscriber terminal, tunneling information of a packet call of the subscriber terminal, and information about whether the subscriber terminal is in use, and the electronic surveillance content information includes calling content information.

8. An electronic surveillance system, which provides electronic surveillance information of a specified subscriber terminal to a law enforcement agency system connected thereto through a network, the electronic surveillance system comprising:
an electronic surveillance administration system that performs an authentication process according to an electronic surveillance request message received from the law enforcement agency system, generates an encryption key according to the authentication result, and provides the generated encryption key to the law enforcement agency system;
a collection system that collects electronic surveillance information of the subscriber terminal including electronic surveillance related information and electronic surveillance content information and outputs the collected information; and
an information delivery system that encrypts the collected and output electronic surveillance information on the basis of the encryption key and transmits the encrypted information to the law enforcement agency system.

9. The electronic surveillance system of claim 8, wherein the electronic surveillance administration system includes:
a codebook database that stores a codebook including an encryption key and an authentication key required for the authentication process;
an authentication unit that receives the electronic surveillance request message including an index of the encryption key and an authentication value from the law enforcement agency system, and performs authentication on the law enforcement agency system on the basis of a first encryption key, a first authentication key, and the authentication value corresponding to the index stored in the codebook database;
a history administration unit that administrates an electronic surveillance history according to the details of the electronic surveillance received from the authorized law enforcement agency system; and
an electronic surveillance controller that generates a second encryption key according to the authentication result and outputs the generated second encryption key to the law enforcement agency system and the information delivery system,
wherein the second encryption key is encrypted with the first encryption key and then transmitted to the law enforcement agency system.

10. The electronic surveillance system of claim 8, wherein the collection system includes:
an electronic surveillance related information extractor that extracts and outputs the electronic surveillance related information under the control of the electronic surveillance administration system; and
an electronic surveillance content information extractor that extracts and outputs the electronic surveillance content information under the control of the electronic surveillance administration system.

11. The electronic surveillance system of claim 8, wherein the information delivery system includes:
an information processing unit that encrypts the electronic surveillance information received from the collection system with the second encryption key, and outputs the encrypted electronic surveillance information;
a control message processing unit that delivers the second encryption key received from the electronic surveillance administration system under the control of the electronic surveillance administration system to the information processing unit, and controls the information processing unit to receive the electronic surveillance information; and
an information transmitter that receives the encrypted electronic surveillance information from the information processing unit and transmits the received electronic surveillance information to the law enforcement agency system.

12. The electronic surveillance system of claim 8, wherein the law enforcement agency system includes:
an administration system that delivers the electronic surveillance request message and the details of the electronic surveillance to the electronic surveillance administration system, receives the second encryption key from the electronic surveillance administration system, and outputs a control message informing of the start of the electronic surveillance and the second encryption key;
an information collection system that administrates the second encryption key received from the administration system and the encrypted electronic surveillance information received from the information delivery system according to the control message received from the administration system; and
an information analysis system that receives the second encryption key and the encrypted electronic surveillance information from the information collection system, decodes the encrypted electronic surveillance information with the second encryption key, and outputs the decoded electronic surveillance information.

13. The electronic surveillance system of claim 8, wherein the electronic surveillance related information includes hardware information relative to traffic processing of the subscriber terminal, tunneling information of a packet call of the subscriber terminal, and information about whether the subscriber terminal is in use.

14. The electronic surveillance system of claim 8, wherein the electronic surveillance content information is communication content information.

15. The electronic surveillance system of claim 9, wherein the details of the electronic surveillance includes a law enforcement agency that performs the electronic surveillance, an object that is subject to electronic surveillance, an electronic surveillance range, and an electronic surveillance duration.

16. The electronic surveillance system of claim 8, wherein the codebook includes an encryption key and an authentication key for authentication, classified according to the encryption key index.

17. The electronic surveillance system of claim 9, wherein the authentication value is generated using an encryption key and an authentication key received from a higher agency system, which authorizes the electronic surveillance request from the law enforcement agency system, and the encryption key and the authentication key are delivered from a codebook having the same contents as the codebook stored in the higher agency system.
